(19) United States
(12) Patent Application Publication
(10) Pub. No.: US 2009/0254410 A1
(43) Pub. Date: Oct. 8, 2009

(54) METHOD AND SYSTEM FOR CONSTRUCTING AND DELIVERING SPONSORED SEARCH FUTURES CONTRACTS

(75) Inventors: Chi-Chao Chang, Santa Clara, CA (US); Ramazan Demir, Sherman Oaks, CA (US); Matthew Hall, San Jose, CA (US); Sai-Ming Li, Santa Clara, CA (US); Darshan Kantak, Pasadena, CA (US); Tak Woon Yan, Palo Alto, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/062,289

(22) Filed: Apr. 3, 2008

(51) Int. Cl. G06Q 30/00

(52) U.S. Cl. 705/10; 705/14

(57) ABSTRACT

A method and system for constructing and delivering sponsored search contracts is provided. In one implementation, the method may include generating a financial instrument with terms, such as a contract, for selling click-throughs. The terms may include a volume of click-throughs, a price, and a core market. The price of the contract may be related to an expected quality of the advertisement. The core market may be described in terms of key words. The contract terms may be communicated to an advertiser. The advertiser may then bind an advertisement to the contract or sell the contract to another advertiser. The contract performance may be tracked and communicated.

### BACKGROUND

The internet has emerged as a powerful tool for finding information. Various search engines are now available that enable internet users, via a web browser, to search for information on a variety of topics. For example, an internet user looking for travel related information may navigate to a website hosting a search engine and submit a search term, such as “travel” to the search engine. After submitting the search term, the search engine may provide a search result list to the internet user. The search result list may include a list of websites, which may include the search term.

In some instances, these services may be provided free of charge to the internet user. To cover the cost for these services, search providers may include advertisements in the search result list. Advertisers may pay the search providers to have their advertisements listed along with other websites in the search result list. In some instances, the advertiser's may pay to have their advertisements associated with key words that may be related to the search terms submitted by the internet user. This may allow the advertiser to target advertisements to internet users that may be more likely to purchase the advertiser's products or services. This type of arrangement has come to be known as sponsored search because the advertisers may be essentially sponsoring the internet users search. The search services providing these services have come to be called sponsored search providers.

To facilitate sponsored searches, some sponsored search providers allow advertisers to bid on key words. In some case, the advertisers bid for placement on a result list. For example, the higher the bid, the higher the placement in a search result list. In other cases, advertisers may bid for a number of search impressions. That is, a number of times their advertisement listing may be shown to an internet user. Yet other advertisers may bid for a number of click-throughs, which corresponds to an internet user clicking the advertisement listing to view an advertiser's landing page.

There may be problems associated with the bidding methods described above. For example, advertisers may have to monitor their bid status continually. If, for example, the advertiser is out bid, the advertiser may lose his place in the search result list. Thus, bidding may be prohibitively expensive to those advertisers that may not be able to afford monitoring their bid status continually. In addition, it may be the case that the sponsored search providers offer these services without any guarantees. That is, there may be no guarantee that an advertiser will actually receive any click-throughs. Thus, the advertiser must assume a certain degree of risk with current systems. Also, it may be shown that the cost for participating in such systems fluctuates over time and may generally increase over time. Thus, advertisers may not be able to manage their advertising campaigns with the degree of predictability that they may desire.

### BRIEF DESCRIPTION

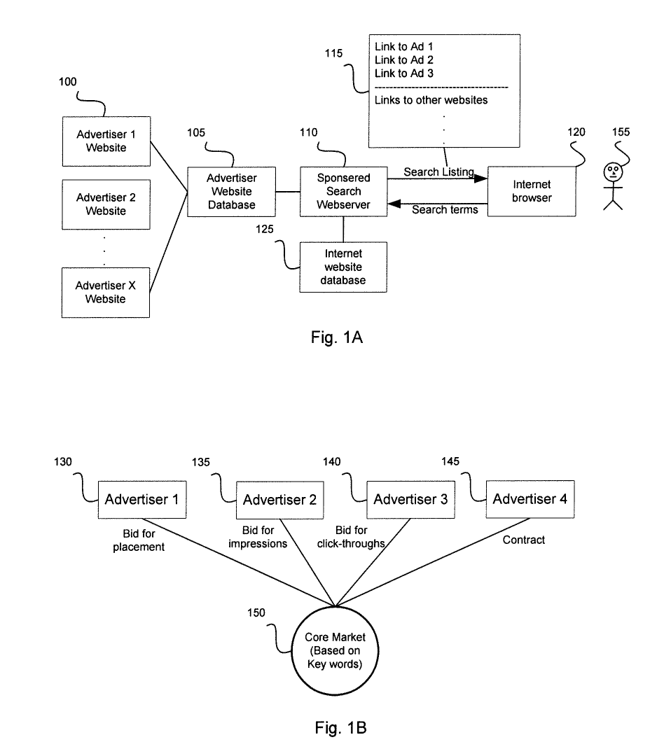

FIG. 1A is a diagram of a system for providing a sponsored search listing.

FIG. 1B is a diagram depicting various ways in which advertisers may participate in a core market.

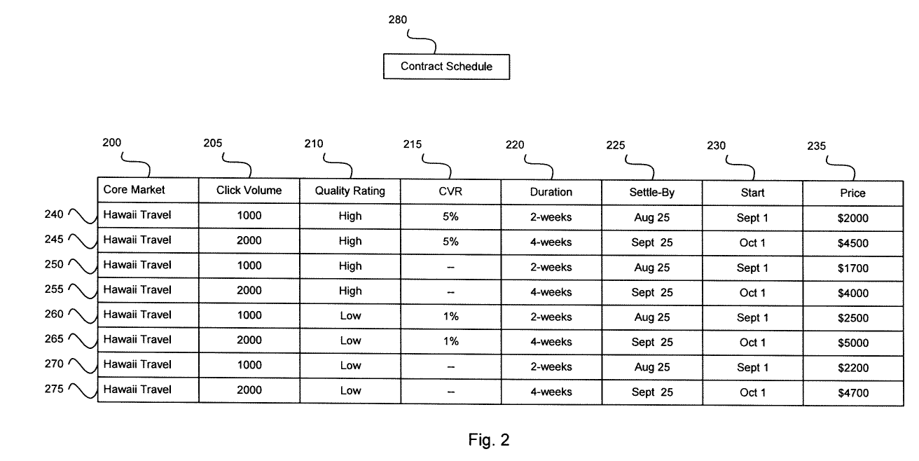

FIG. 2 is a contract schedule including several contract offerings that may be provided to an advertiser.

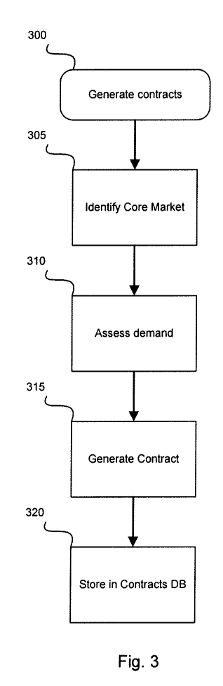

FIG. 3 is a block diagram of a flow chart for identifying contract opportunities and generating contracts.

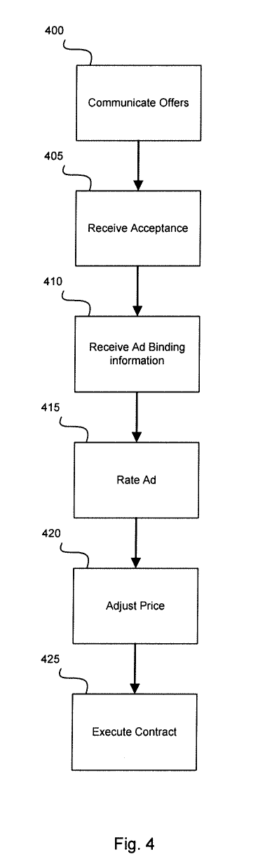

FIG. 4 is a block diagram of a flow chart for negotiating a contract with an advertiser.

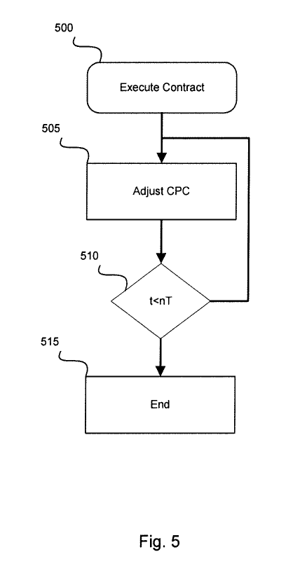

FIG. 5 is a block diagram of a flow chart for optimizing key word bid amounts.

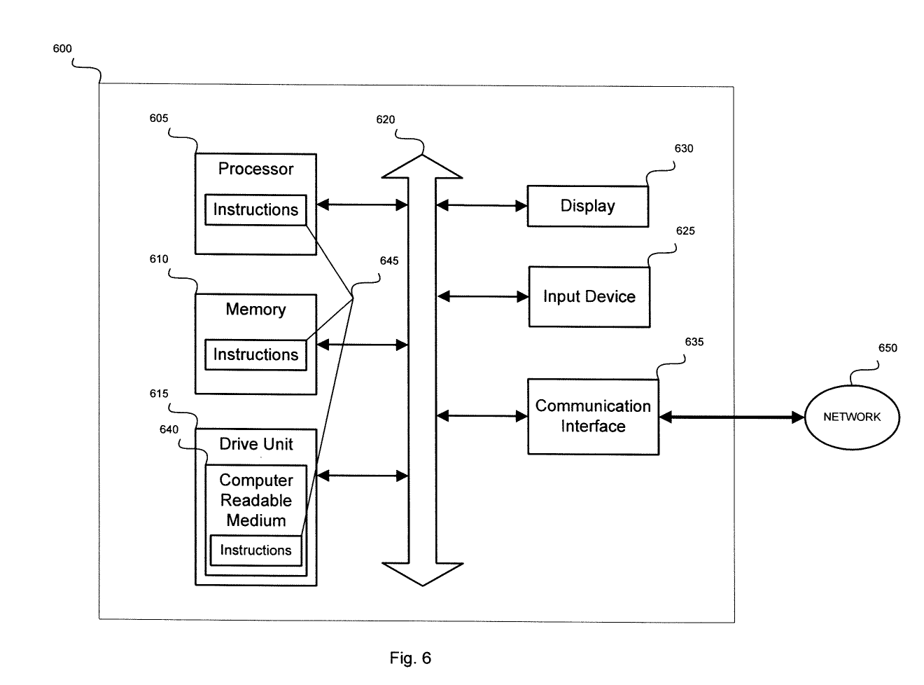

FIG. 6 illustrates a general computer system, which may represent a sponsored search web server, advertiser websites, or any of the other computing devices referenced herein.

### DETAILED DESCRIPTION OF THE INVENTION

To address the problems outlined above, a method and system for constructing and delivering sponsored search futures contracts is provided. The method and system may enable shifting some of the risks associated with participating in web based advertising from advertisers to sponsored search providers. The method and system may also enable the advertiser to hedge against increasing costs. This in turn may enable advertisers to manage their respective campaigns with more predictability ahead of time and with lower transaction costs.

To facilitate this, the method and system may include generating a financial instrument with terms, such as a contract. The terms may include a price term, a duration term, and a volume of contract unit term. The contract unit may correspond to a number of click-throughs, a number of impressions, a number of call leads, or a number of conversions. An impression may correspond to an advertisement link being displayed in response to a search, a click-through may corresponds to clicking the advertisement link, a call lead may correspond to calling the telephone number associated with the advertisement link, and a conversion may correspond to a sale associated with the advertisement link. The terms may also include a core market term that may be described in terms of key words or categories

The price of the contract may be related to an expected quality of the advertisement. The price term may also be a function of the duration of the contract and the contract unit volume for a given core market. The function may include a concave pricing function that may be utilized to limit reseller activity. That is, the average price for a contract unit may be set large enough to make it uneconomical for resellers to buy a large volume of contract units, break up the contract volume into smaller volumes and then resell the smaller volume contracts.

Finally, the price term may comprise a premium rate that may be increased as the volume of contract unit term is increased and the duration term is decreased.

The contract terms may be communicated to an advertiser. The advertiser may then bind an advertisement to the contract or sell the contract to another advertiser. The contract performance may be tracked so as to deliver the number of click-throughs, impressions, call leads, and/or conversions called for in the contract.

FIG. 1A is a diagram of a system for providing a sponsored search listing. Referring to FIG. 1A, there is shown a series of advertiser websites 100, an advertiser website database 105, an internet website database 125, a sponsored search web server 110, search listing results 115, an internet browser 120, and a searcher 155. The sponsored search web server 110 may comprise suitable logic, code, and or circuitry that may enable generating a search result list 115 associated with search terms and may be maintained by a sponsored search provider. The sponsored search web server 110 may correspond to computer software running on a computer. The computer may comprise components, such as memories, hard drives, and network adapters. The network adapters may be suitable for communicating information utilizing various network protocols. For example, the network adapters may be adapted to communicate over the internet.

The advertiser website database 105 and the internet website database 125 may be coupled to the sponsored search web server 110. The advertiser website database 105 may include advertisement listings corresponding to the advertiser websites 100 as well as key words that may be associated with the advertisement listings. The internet website database 125 may include links to websites found on the internet. The internet website database 125 may, for example, be populated by executing a web crawler algorithm on the internet. This algorithm may search the internet for websites and collect terms found on the websites for association with the website and store links to the websites along with their associated terms.

In operation, a searcher 155 may, through an internet browser 120, navigate to a website hosted on the sponsored search web server 110 and specify search terms. The sponsored search web server 110 may then provide a search result list 115 that may be related to the search terms provided by the searcher 155. The sponsored search web server 110 may accomplish this by searching through the advertiser website database 105 for any advertiser websites 100 that have key words that may be related to the search terms provided by the searcher 155. The sponsored search web server 110 may also display those websites stored in the internet website database 125 with terms that match the search terms. The name “sponsored search” may come from the way in which the search result list 115 is presented to the searcher 155. Although the search may appear free to the searcher 155, in actuality, the cost may be borne by those advertisers who have their advertisement listings displayed in the search result list 115. Those advertisers may be sponsoring the cost of the search for the searcher 155.

FIG. 1B is a diagram depicting various ways in which advertisers may participate in a core market. Referring to FIG. 1B, there is shown a first advertiser 130, second advertiser 135, third advertiser 140, fourth advertiser 145, and a core market 145. The core market 145 may correspond to a group of key words. For example, key words such as, travel, vacation, holiday may correspond to a core travel market. There are several ways in which an advertiser may choose to participate in a core market. For example, a first advertiser 130 may bid to have an advertisement listing placed in a certain position within a search result list. The first advertiser 130 may bid on specific key words belonging to a particular core market. Generally speaking, the higher the bid, the higher the placement of the advertisement listing in the search result list 115.

A second advertiser 135 may bid for a certain number of searcher impressions. For example, the second advertiser 135 may bid to have an advertisement listing displayed in response to searcher 155 search requests. This manner of bidding may differ from the previous method in that the placement of the advertisement listing may vary. A third advertiser 140 may bid for a certain number of click-throughs. For example, the third advertiser 140 may bid on the number of times in which a searcher 155 clicks on the third advertiser's 140 advertisement listing. One issue that may arise in the above bidding methods may be that a second advertiser 135 may outbid the first advertiser 130. When this happens, the first advertiser 130 may lose his placement, number of impressions, or number of click-throughs. In order to mitigate this problem, the first advertiser 130 may have to periodically check his relative bid status against others and perhaps increase his bid.

An advertiser may also participate in a core market 145 by way of a financial instrument, such as a contract, for a selling a specified number of click-throughs for a specified amount. For example, a fourth advertiser 145 may purchase a contract for participating in the core market 145. The contract may include an engagement or contract unit term, such as a quantity of click-throughs, conversions, leads, or calls. A core market term may be specified. The core market may be further specified by providing key words or categories.

Targeting terms may be specified as well. For example, geographic targets may specify locations where the advertisement may be listed. Demographic targeting may be utilized to target classes of individuals, such as males or females. Behavioral demographics may be utilized to target individuals with, for example, certain shopping patterns. The source of traffic may also be specified. The source of traffic may correspond to a website where search traffic, or user queries may be come from.

A duration of the contract term, price term and a quality rating term corresponding to the quality of an advertisement may be provided. The price term of the contract may vary based on the quality of the advertisement provided by the fourth advertiser 145. The advertisement may correspond to an advertisement listing or creative and an advertisement landing page. For example, the price for a given number of click-throughs may be less where the quality of the advertisement is relatively high compared to other advertisement that may be targeting the same core market 145. At least one advantage of this approach as compared to those above is that this method may guarantee the fourth advertiser 145 a certain number of click-throughs without requiring the fourth advertiser 145 to periodically change a bid.

FIG. 2 is a contract schedule including several contract offerings that may be provided to an advertiser. Referring to in FIG. 2, there is shown a core market description column 200, a contract unit volume column 205, a quality rating column 210, a number of conversions column 215, a duration column 220, a settle-by date column 225, a start date column 230, a price column 235, and several offers 240-275. The columns shown in FIG. 2 may correspond to the terms of a contract. Each row shown in FIG. 2 may correspond to a different contract with different terms.

The core market description column 200 may include a brief description of the core market 145 where an advertisements may be targeted. The description may come by way of sample key words within that market. For example, the sample key words “Hawaii” and “Travel” may be utilized to represent travel related markets for Hawaii. The core market may also be identified by category. In one embodiment, prospective buyers of the contract may not be allowed to further inspect the core market 145.

The contract unit volume column 205 may correspond to a number of click-throughs, impressions, call leads, or conversions that may be provided.

The quality rating column 210 may correspond to a minimum quality index for an advertisement bound to a contract. For example, the quality index may include “High”, “Medium” and “Low” indices. A “High” index in a contract may indicate that in order for this contract to be utilized the advertisement listing may have to be of a high quality as compared to other advertisement listings targeting the same core market 145. One reason for doing this may be that higher quality advertisement may naturally attract more click-throughs than lower quality advertisement listings. In this case, less cost on the part of the sponsored search provider may be needed to achieve a desired click-through-rate. Thus, the sponsored search provider may be able to offer the contract for a lower price. By contrast, where the advertisement quality is low, it may require more cost on the part of the sponsored search provider to achieve a desired click-through rate. In this case, the sponsored search provider may provide a contract with a longer duration so at to deliver the desired volume at the contract price.

The number of conversions column 215 may correspond to a guaranteed number of conversions. That is, this column may be utilized to guarantee the number of times a particular advertisement listing may be clicked.

The settle-by date column 225 may correspond to a date by which the contract may be submitted for final review with an advertisement listing bound to the contract. The start date column 230 may correspond to a date by which the performance of the contract may begin and the duration column 220 may correspond to the amount of time for which performance may be rendered. One of ordinary skill will appreciate that an end date may be provided instead of a duration. In one embodiment, typical contract durations may be 4 weeks, 8 weeks, or 12 weeks.

The price column 235 may correspond to the price of a contract. The price term in the contract schedule 280 may be comprised of a base price plus a premium. In one embodiment, the base price may be computed according to the following equation:

Base price=volume of clicks×average cost-per-click (CPC)

where the volume of clicks corresponds to the contract number of clicks and the average cost-per-click corresponds to an average amount spent by advertisers on key words in the core market. The base price may also be adjusted based on the quality of an advertisement. In this case, a contract with higher quality may have a lower base price than a contract with an average quality rating.

The base price may also be computed by including an accurate model of the click supply in terms of both impressions and click-through rates, an accurate model of the demand (e.g., the amount spent by advertisers), or a measure of the implied volatility for prices in that core market. In one embodiment, the risk created by introducing contracts may be minimized by capping the volume in a core market exposed to guaranteed contracts. In addition or alternatively, core markets with small to moderate amounts of spend where prior knowledge of potential demand realization exists may be targeted. The implied volatility pricing may be computed by utilizing, for example, the Black-Scholes formulae for option pricing.

In another embodiment, the base price may be based on conversion data. For example, in core markets where conversion data may be abundant and reliable, the base price may be calculated according to the following equation:

Base price=volume of clicks×conversion rate×average cost per acquisition

where the volume of clicks corresponds to the number of clicks seen in a core market, the conversion rate corresponds to an expected conversion rate for the key words that make up the core market description 200, and the average cost per acquisition (CPA) corresponds to the average amount an advertiser spends divided by a number of sales the advertiser makes. It may be necessary to accurately compute the conversion rate so as to minimize the risk to the sponsored search provider.

In addition to a base price, the price term may also include a premium. The premium may enable the sponsored search provider to absorb some of the risks introduced by an advertiser. The premium may account for the duration of the contract. For example, it may be the case that the longer the contract, the higher the risk, because the sponsored search provider may be more exposed to market fluctuations. In this case, a higher premium may be charged. There may also be risks associated with executing short contracts because the sponsored search provider may not have enough time to compensate for under-performance.

The premium may also account for an estimated cost savings in campaign management and analytics. Costs may also be saved by analyzing advertiser behaviors such the usage of enterprise web services, user interface interactions, usage of forecasting tools, and campaign optimization adoption. The enterprise web services may correspond to an open API for advertises and agencies to automate campaign management. Forecasting tools may be tools that enable and advertiser to forecast the amount of traffic, clicks, and cost into the future. The premium may also account for additional risks in conversion-rated pricing and protect against poor quality advertisers who may buy up as many contracts as possible and engage in arbitrage opportunities. This protection may be needed to cover bad quality assessments and arbitrate ranges.

As noted above, the present embodiment enables shifting some of the risks associated with participating in web based advertising from advertisers to sponsored search providers. However, to mitigate the risks to the sponsored search provider, in addition to estimating probabilities of clicks and conversions, the sponsored search provider may have to price contracts optimally so as to discover the opportunities where contracts may be delivered with confidence. FIG. 3 is a block diagram of a flow chart for identifying such contract opportunities and for generating the contracts. Referring to FIG. 3, at block 305 data related to the current landscape of the sponsored search advertising markets may be analyzed to identify opportunities. Some examples of core markets where opportunities may exist include, core markets with a large share of click-throughs going to advertising agencies instead of small advertisers or core markets with a low average cost-per-click (CPC). That is core markets where the CPC may not have reacted to marketplace initiatives like quality-based pricing and market reserve prices. Quality-based pricing (QBP) may correspond to a pricing model where advertisers may be charged commensurate with the quality of the publisher, which may be where the clicks originate from. Market reserve prices (MRP) are prices based on a minimum/reserve/floor price for a keyword and/or core market. Other examples include, core markets with stagnated advertiser spend, core markets identified by Marketing, Business, Advertiser and Partner teams as business opportunities, and core markets with keywords that have high click volume “unbidded” terms.

At block 310, the demand for potential contracts in these core markets may be assessed for the near future. Assessing the demand may include evaluating supply/search projections and forecasts, click-through rate projects, and average prices for that core market. Assessing the demand may also include getting feedback from advertisers who might be interested in that market. In addition, one may probe the demand by starting with lower prices and adjusting the prices up accordingly.

At block 315 a contract for taking advantage of an identified core market opportunity may be generated. To attract as many advertisers as possible, multiple options may be provided. For example, terms such as the volume of click-throughs, the expected quality rating, the expected conversion rate, the contract start date and duration, and the price may be varied. The more contracts provided, the more flexibility may be offered.

At block 320, the contracts generated in the previous step may be stored in a database of contracts. This database may include multiple contracts targeting multiple core markets. The contracts stored in the database may be available for inspection by advertisers who may which to participate in those markets.

FIG. 4 is a block diagram of a flow chart for negotiating a contract with an advertiser. In block 400, a contract offering may be communicated to an advertiser. For example, offers may be communicated to existing customers via the same tools those advertisers may utilize to bid on key words. These tools may be adapted to provide alerts and notifications of current contract offerings. In one embodiment, the alerts and notifications may be communicated to advertisers when a certain critical mass of contract offers may be reached. Offers to new advertisers may be communicated via typical sales channels, such as direct marketing.

At block 405, an advertiser interested in a contract may purchase it by paying the flat price of the contract. Once purchased, an advertiser may choose to transfer the contract. For example, the advertiser may sell the contract to a second advertiser for an amount the two advertisers agree upon. In this regard, the price of the contract may be set so as to limit arbitrage opportunities. That is, so as to prevent advertisers from purchasing large contracts and subdividing them into smaller contracts for resale into the marketplace. Should the advertiser decide to keep the contract, then at block 410 the advertiser may bind an advertisement to the contract. The advertisement may be comprised of advertisement listing or creative and a landing page. Once bound, the advertisement may be submitted to the sponsored search provider for acceptance. In one embodiment, it may be necessary to bind the advertisement to the contract by, for example, the settlement date of the contract. In some instances, the sponsored search provider may or may not choose to refund the cost of the contract to the advertiser where the advertisement may not have been submitted by the settlement date.

At block 415, the sponsored search provider may measure the quality of the advertisement. In cases where the sponsored search provider may not be aware of the historical performance of the advertisement, such as when the advertiser or advertisement may be new, the sponsored search provider may choose to utilize the services of an Advertisement Quality Service. Alternatively, the sponsored search provider may use a combination of editorial judgment and a quality score. The quality score may be calculated by a model trained on static relevance features.

At block 420, the price of the contract may be adjusted. For example, in some instances, the quality of the advertisement may not match the quality rating term of the purchased contract. In such instances, the sponsored search provider may, for example, charge or refund to the advertiser the difference between the price of the purchased contract and a contract with a quality rating which more accurately reflects the quality of the advertisement bound by the advertiser. Alternatively, the sponsored search provider may reject the contract and may refund the contract price to the advertiser.

In another embodiment, the quality of the advertisement may be assessed during a trial period. In this case, the price of the contract may, for example, be split into two payments. The first payment may be made at the purchase time of the contract. The second payment may be paid upon the completion of experiments to determine the relative quality of the advertisement. The experiments may include, for example, measuring the number of click-throughs and the conversion rate of an advertisement and comparing the measured results to advertisements with predetermined quality ratings.

At block 425, the contract may be executed. This may be accomplished by introducing the advertisement into the core market utilizing existing bidding schemes. For example, on behalf of the advertiser, the sponsored search provider may create an advertisement campaign for the advertiser. In doing so, the sponsored search provider may associate key words from the core market with the campaign and may bid or specify a cost-per-click (CPC) on those key words. All of this may be done on behalf of the advertiser. At every iteration in the bidding process, the sponsored search provider may set the CPC for the key words in such a way as to provide to the advertiser the agreed click volume over the duration of the contract. At least one advantage of this approach is that it may free the advertiser from the work of continually monitoring the placement of the advertiser's advertisement listings.

FIG. 5 is a block diagram of a flow chart for optimizing key word bid amounts. At block 500, the contract execution may have begun. For example, a sponsored search provider may have created an advertisement campaign for the advertiser and may have selected key words that appear in the chosen core market. At block 505 an optimal placement for each keyword in the contract may be determined so as to achieve the volume of clicks required by the contract. Several formulations may be available for determining the optimal placement.

In a first embodiment, the goal of the formulation may be to determine the optimal placement for each keyword in the contract such that the total number of clicks may be maximized and the cost of fulfilling the contract may be less than the future cost of the contact C, given a future contract, priced at C, including k keywords, guaranteeing a delivery of N clicks over a time period t₀ to t_{f}, and a conversion rate better than α̅. The cost of fulfilling the contract may be defined as the revenue that the sponsored search provider may have received from the contract holder had the contract holder been charged for the clicks received as though the contract holder had placed bids for those keyword placements. The following describes the formulation of the first embodiment:

Notations:
cⱼ—position occupied by contract holder in keyword j
x_{j,i}—advertiser independent CTR for keyword j at position i
b_{j,i}—bid of advertiser occupying position i for keyword j
q_{j,i}—quality of advertiser occupying position i for keyword j
q_{j,c}—quality of the contract holder for keyword j
nⱼ—number of current advertisers in keyword j
Sⱼ—number of searches per unit time for keyword j
αⱼ—conversion rate of the contract holder in keyword j
T—duration of the contract=t_{f}−t₀

Assumptions:
1. The index i is ordered by expected revenue, i.e.

b_{j,i}q_{j,i}≧b_{j,i+1}q_{j,i+1}∀i,j
2. The auction mechanism is GSP price and rank by expected revenue
3. Future contract placement does not affect CPC of non-contract holding advertisers.
   For keyword j, after the insertion of the contract holder at position cⱼ, all existing advertisers occupying position cⱼ and below will be displaced by one position. The total number of clicks for this keyword during the contract period will then become

$$( ( {\sum }_{i = 1}^{{c}_{j} - 1} {x}_{j , i} {q}_{j , i} ) + {x}_{j , {c}_{j}} {q}_{j , c} + ( {\sum }_{i = {c}_{j}}^{{n}_{j}} {x}_{j , i + 1} {q}_{j , i} ) ) {TS}_{j}$$

The CPC of contract holder for keyword j is given by the GSP auction mechanism as

$$\frac{{b}_{j , {c}_{j}} {q}_{j , {c}_{j}}}{{q}_{j , c}}$$

The expected number of clicks obtained by the contract holder for keyword j may be given by

x_{j,c}_{ⱼ}q_{j,c,TS}ⱼ

Therefore, the total cost of fulfilling the contract may be given by

$${\sum }_{j = 1}^{k} {x}_{j , {c}_{j}} {b}_{j , {c}_{j}} {q}_{j , {c}_{j}} {TS}_{j}$$

The expected overall conversion rate of the contract holder may be given by

$$\frac{{\sum }_{j = 1}^{k} {α}_{j} {x}_{j , {c}_{j}} {q}_{j , c} {TS}_{j}}{{\sum }_{j = 1}^{k} {x}_{j , c} {q}_{j , c} {TS}_{j}}$$

To achieve a minimum overall conversion rate of α̅implies

$${\sum }_{j = 1}^{k} ( {α}_{j} - \overline{α} ) {x}_{j , {c}_{j}} {q}_{j , c} {S}_{j} \geq 0$$

Combining the above, the optimization problem can be formulated as

$${max}_{{c}_{1} , … , {c}_{k}} {\sum }_{j = 1}^{k} ( ( {\sum }_{i = 1}^{{c}_{j} - 1} {x}_{j , i} {q}_{j , i} ) + {x}_{j , {c}_{j}} {q}_{j , c} + ( {\sum }_{i = {c}_{j}}^{{n}_{j}} {x}_{j , i + 1} {q}_{j , i} ) ) {TS}_{j}$$

$$s . t . {\sum }_{j = 1}^{k} {x}_{j , {c}_{j}} {q}_{j , c} {TS}_{j} \geq N$$

$${\sum }_{j = 1}^{k} ( {α}_{j} - \overline{α} ) {x}_{j , {c}_{j}} {q}_{j , c} {S}_{j} \geq 0$$

$${\sum }_{j = 1}^{k} {x}_{j , {c}_{j}} {b}_{j , {c}_{j}} {q}_{j , {c}_{j}} {TS}_{j} \leq C$$

In a second embodiment, the formulation may determine the optimal placement for each keyword in the contract such that the revenue displaced may be minimized, given a future contract that includes k keywords that guarantees a delivery of N clicks over time period t₀ to t_{f,} and a conversion rate better than α̅. The following describes the formulation of the second embodiment:

Notations:
cⱼ—position occupied by contract holder in keyword j
x_{j,i}—advertiser independent CTR for keyword j at position i
b_{j,i}—bid of advertiser occupying position i for keyword j
q_{j,i}—quality of advertiser occupying position i for keyword j
q_{j,c}—quality of the contract holder for keyword j
nⱼ—number of current advertisers in keyword j
Sⱼ—number of searches per unit time for keyword j
αⱼ—conversion rate of the contract holder in keyword j
T—duration of the contract=t_{f}−t₀

Assumptions:
1. The index i is ordered by expected revenue, i.e.

b_{j,i}q_{j,i}≧b_{j,i+1}q_{j,i+1}∀i,j
2. The auction mechanism is GSP price and rank by expected revenue
3. Future contract placement does not affect CPC of non-contract holding advertisers.
   Based on the above assumptions, the displaced revenue in keyword j due to insertion of the ad of a contract holder at position cⱼ may be given by

displaced_revenue=original_revenue−new_revenue

$$\begin{matrix}= ( {\sum }_{i = 1}^{{n}_{j}} \frac{{b}_{j , i + 1} {q}_{j , i + 1}}{{q}_{j , i}} {x}_{j , i} ) {TS}_{j} - ( {\sum }_{i = 1}^{{c}_{j} - 1} \frac{{b}_{j , i + 1} {q}_{j , i + 1}}{{q}_{j , i}} {x}_{j , i} + \\ {\sum }_{i = {c}_{j}}^{{n}_{j}} \frac{{b}_{j , i + 1} {q}_{j , i + 1}}{{q}_{j , i}} {x}_{j , i + 1} ) {TS}_{j} \\ = ( {\sum }_{i = c}^{{n}_{j}} \frac{{b}_{j , i + 1} {q}_{j , i + 1}}{{q}_{j , i}} ( {x}_{j , i} - {x}_{j , i + 1} ) ) {TS}_{j}\end{matrix}$$

The expected total clicks obtained by the contract holder may be given by

$${\sum }_{j = 1}^{k} {x}_{j , {c}_{j}} {q}_{j , c} {TS}_{j}$$

The expected overall conversion rate of the contract holder may be given by

$$\frac{{\sum }_{j = 1}^{k} {α}_{j} {x}_{j , {c}_{j}} {q}_{j , c} {TS}_{j}}{{\sum }_{j = 1}^{k} {x}_{j , {c}_{j}} {q}_{j , c} {TS}_{j}}$$

To achieve a minimum overall conversion rate of α̅implies

$${\sum }_{j = 1}^{k} ( {α}_{j} - \overline{α} ) {x}_{j , {c}_{j}} {q}_{j , c} {S}_{j} \geq 0$$

Combining the equations above, the optimization problem can be formulated as

$${min}_{{c}_{1} , … , {c}_{k}} {\sum }_{j = 1}^{k} ( {\sum }_{i = {c}_{j}}^{{n}_{j}} \frac{{b}_{j , i + 1} {q}_{j , i + 1}}{{q}_{j , i}} ( {x}_{j , i} - {x}_{j , i + 1} ) ) {TS}_{j}$$

$$s . t . {\sum }_{j = 1}^{k} {x}_{j , {c}_{j}} {q}_{j , c} {TS}_{j} \geq N$$

$${\sum }_{j = 1}^{k} ( {α}_{j} - \overline{α} ) {x}_{j , {c}_{j}} {q}_{j , c} {S}_{j} \geq 0$$

In block 510, if the contract has not yet expired, then the process may return to block 500, where the formulations described above may be recomputed to determine an optimal placement. If the contract has expired, then at block 515 the advertiser's advertisement listing may be removed from the database of advertisement listings associated with the core market. In some embodiment the advertiser may be notified when this condition occurs. This may give the advertiser an opportunity to purchase another contract.

FIG. 6 illustrates a general computer system, which may represent a sponsored search web server, advertiser websites, or any of the other computing devices referenced herein. The computer system 600 may include a set of instructions 645 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as, a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later developed devices for analyzing and processing data. The processor 605 may implement a software program, such as code generated manually (i.e., programmed).

The computer system 600 may include a memory 610 that can communicate via a bus 620. The memory 610 may be a main memory, a static memory, or a dynamic memory. The memory 610 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 620, such as a liquid crystal display (LCD), an organic light emitting diode (OLED), a flat panel display, a solid state display, a cathode ray tube (CRT), a projector, a printer or other now known or later developed display device for outputting determined information. The display 620 may act as an interface for the user to see the functioning of the processor 605, or specifically as an interface with the software stored in the memory 610 or in the drive unit 615.

Additionally, the computer system 600 may include an input device 625 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal; so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 625, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The functions described herein may also be accomplished by way of an application program interface for facilitating a review of mobile advertisement listing. Information associated with a mobile advertisement listing and at least one carrier and at least one keyword associated with the mobile advertisement listing may be communicated via the application program interface. Reviewing rules associated with a carrier for the carrier associated with the mobile advertisement listing may be communicate via the application program interface as well. An indication of whether the mobile advertisement listing is approved for the carrier based on the displayed reviewing rules associated with the carrier may be received via the application program interface.

The functions described herein may also be accomplished by way of a system for facilitating a review of mobile advertisement listing. The system may include one or more circuits that enable communicating, via an application program interface, information associated with a mobile advertisement listing and at least one carrier and at least one keyword associated with the mobile advertisement listing. The circuits may also enable communicating via said application program interface reviewing rules associated with a carrier for the at least one carrier associated with the mobile advertisement listing; and receiving, via said application program interface an indication of whether the mobile advertisement listing is approved for the carrier based on the displayed reviewing rules associated with the carrier.

The various embodiments disclosed herein advantageously allow for the review of mobile advertisement listing by allowing an editor to review the mobile advertisement information and either allow or reject the mobile advertisement listing on a carrier by carrier basis. Another advantage is that the editor may see how a mobile advertisement listing may appear on various mobile devices via an emulator.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

From the foregoing, it may be seen that the present embodiment provides an alternative approach for an advertiser who may desire to participate in sponsored search advertising. Rather than utilizing bidding schemes, which may require the advertiser to continually monitor his bid as compared to other bids by other advertisers, this approach guarantees the advertiser a certain number of click-throughs. This may be more economically beneficial to an advertiser that may be cost conscious. The present embodiment may enable shifting some of the risks associated with participating in web based advertising from advertisers to sponsored search providers. It may also enable the advertiser to hedge against increasing costs. This in turn may enable advertisers to manage their respective campaigns with more predictability ahead of time and with lower transaction costs.

What is claimed is:

1. A method for providing internet based advertising space, the method comprising:
generating a financial instrument for selling click-throughs, wherein the financial instrument includes terms and those terms include a price term, a duration term, and a volume of contract unit term wherein the volume of contract unit term corresponds to at least one of: a number of click-throughs term, a number of impressions term, a number of call leads term, and a number of conversions term;
communicating at least some of the terms of the financial instrument to an advertiser; and
associating an advertisement of the advertiser with the financial instrument, wherein the price term of the financial instrument is based at least in part on a quality rating of the advertisement.

2. The method according to claim 1, further comprising tracking the performance of the financial instrument so as to deliver at least one of: a number of click-throughs, a number of impressions, a number of call leads, and a number of conversion, during the duration of the financial instrument.

3. The method according to claim 1, wherein the price term is a function of at least the duration of the financial instrument and the contract unit for a given core market.

4. The method according to claim 3, wherein the function comprises a concave pricing function that limits reseller activity.

5. The method according to claim 3, wherein the price term comprises a premium rate that increases as the volume of contract unit term is increased and the duration term decreases.

6. The method according to claim 1, wherein the advertisement further comprises at least one of: a creative listing and a landing page.

7. The method according to claim 1, wherein the terms comprise a core market description and the core market is associated with at least one of: key words, and categories.

8. The method according to claim 1, wherein the terms comprise a targeting term associated with at least one of: geographic targets, demographic targets, and behavioral targets.

9. A machine-readable storage medium having stored thereon, a computer program comprising at least one code section for providing internet based advertising space, the at least one code section being executable by a machine for causing the machine to perform acts of:
generating a financial instrument for selling click-throughs, wherein the financial instrument includes terms and those terms include a price term, a duration term, and a volume of contract unit term wherein the volume of contract unit term corresponds to at least one of: a number of click-throughs term, a number of impressions term, a number of call leads term, and a number of conversions term;
communicating at least some of the terms of the financial instrument to an advertiser; and
associating an advertisement of the advertiser with the financial instrument, wherein the price term of the financial instrument is based at least in part on a quality rating of the advertisement.

10. The machine-readable storage medium according to claim 9, wherein the at least one code enables the machine to perform that acts of tracking the performance of the financial instrument so as to deliver at least one of: a number of click-throughs, a number of impressions, a number of call leads, and a number of conversion, during a duration of the financial instrument.

11. The machine-readable storage medium according to claim 9, wherein the price term is a function of at least the duration of the financial instrument and the contract unit for a given core market.

12. The machine-readable storage medium according to claim 11, wherein the function comprises a concave pricing function that limits reseller activity.

13. The machine-readable storage medium according to claim 11, wherein the price term comprises a premium rate that increases as the volume of contract unit term is increased and the duration term decreases.

14. The machine-readable storage medium according to claim 9, wherein the advertisement further comprises at least one of: a creative listing and a landing page.

15. The machine-readable storage medium according to claim 9, wherein the terms comprise a core market description and the core market is associated with at least one of: key words, and categories.

16. The machine-readable storage medium according to claim 9, wherein the terms comprise a targeting term associated with at least one of: geographic targets, demographic targets, and behavioral targets.

17. A system for providing internet based advertising space, the system comprising:
circuitry that enables generating a financial instrument for selling click-throughs, wherein the financial instrument includes terms and those terms include a price term, a duration term, and a volume of contract unit term wherein the volume of contract unit term corresponds to at least one of: a number of click-throughs term, a number of impressions term, a number of call leads term, and a number of conversions term;
the circuitry is configured to communicate at least some of the terms of the financial instrument to an advertiser; and
associating an advertisement of the advertiser with the financial instrument, wherein the price term of the financial instrument is based at least in part on a quality rating of the advertisement.

18. The system according to claim 17, wherein the circuitry enables tracking the performance of the financial instrument so as to deliver at least one of: a number of click-throughs, a number of impressions, a number of call leads, and a number of conversion, during a duration of the financial instrument.

19. The system according to claim 17, wherein the price term is a function of at least the duration of the financial instrument and the contract unit for a given core market.

20. The system according to claim 19, wherein the function comprises a concave pricing function that limits reseller activity.

21. The system according to claim 19, wherein the price term comprises a premium rate that increases as the volume of contract unit term is increased and the duration term decreases.

22. The system according to claim 17, wherein the terms comprise a core market description and the core market is associated with at least one of: key words, and categories.

23. The system according to claim 17, wherein the advertisement further comprises at least one of: a creative listing and a landing page.

24. The system according to claim 17, wherein the terms comprise a targeting term associated with at least one of: geographic targets, demographic targets, and behavioral targets.

25. A method for generating a contract for providing internet based advertising space, the method comprising:
analyzing data related to a current landscape of sponsored search advertising markets to identify core market opportunities;
assessing a near future demand for targeting core markets identified;
generating a contract with terms for targeting the identified core markets when there is a demand for targeting identified core markets;
displaying at least some of the terms of the generated contract on a computer display.

26. The method according to claim 25, wherein core market opportunities comprise at least one of:
a) markets with a large share of click-throughs going to advertising agencies instead of small advertisers or markets with a low average cost-per-click,
b) markets with stagnated advertiser spend, and
c) markets with keywords that have high click volume on “unbidded” terms.

27. The method according to claim 25, wherein assessing the demand further comprises at least one of:
a) evaluating supply and search projections and forecasts, click-through-rate projections, and average prices for a core market;
b) getting feedback from advertisers operating in a core market; and
c) probing demand by initially providing contracts with a low price term and then gradually increasing the price term until demand decreases.
